(19) United States
(12) Patent Application Publication
(10) Pub. No.: US 2026/0304218 A1
(43) Pub. Date: Oct. 1, 2026

(54) SYSTEM AND APPARATUS FOR CONTROLLING CONGESTION IN SIDELINK POSITIONING AND A METHOD IN ASSOCIATION THERETO

(71) Applicant: AUMOVIO GERMANY GMBH, Frankfurt am Main (DE)

(72) Inventors: Reuben GEORGE STEPHEN, Singapore (SG); Rikin SHAH, Langen, Hessen (DE); David GONZALEZ GONZALEZ, Egelsbach, Hessen (DE); Shravan Kumar KALYANKAR, Singapore (SG); Hojin KIM, Regensburg (DE)

(73) Assignee: AUMOVIO GERMANY GMBH, Frankfurt am Main (DE)

(21) Appl. No.: 19/479,802

(22) PCT Filed: May 8, 2024
(86) PCT No.: PCT/EP2024/062752

§ 371 Date: Oct. 29, 2025

(30) Foreign Application Priority Data
May 9, 2023 (DE) 10 2023 204 289.4

(51) Int. Cl. H04W 28/02; H04W 64/00; H04W 72/02; H04W 92/18

(52) U.S. Cl. CPC H04W 28/0289; H04W 64/00; H04W 72/02; H04W 92/18

(57) ABSTRACT

A system, an apparatus, a device, and a method for controlling congestion in sidelink positioning are disclosed. The method includes determining a resource pool allocation for selecting resources; generating at least one parameter based on the resource pool allocation and a past resource selection configuration; configuring a current resource selection for a user device based on the at least one parameter; communicating the current resource selection configuration to the user device for controlling congestion in the allocated resource pool.

### FIELD OF INVENTION

The present disclosure generally relates to one or both of a system and an apparatus for controlling congestion in sidelink (SL) positioning and in association with, for example, a User Equipment (UE) and/or a base station, usable for communication. The present disclosure further relates a method which can be associated with the system and/or the apparatus.

### BACKGROUND OF INVENTION

Generally, wireless networks provide network connectivity through radio interfaces to mobile communication devices or user equipment (UE), such as smart phones. Energy efficiency and power saving for controlling congestion in resource pools (RPs) can be helpful in communication networks, for example, a 3rd Generation Partnership Project (3GPP) 5G (fifth generation) New Radio (NR) standard-based telecommunications network.

Current techniques may not address the issue of controlling congestion when many UEs autonomously select sidelink (SL) positioning resources in a dedicated or shared RP. There can be congestion in the RP due to the selection of transmission parameters (e.g., transmission power) by the UEs. Thus, the current techniques may not facilitate energy efficiency and power saving in an optimal manner.

The present disclosure contemplates that it would be helpful to address or at least mitigate one or more issues in relation to conventional techniques for facilitating energy efficiency and power saving when allocating resources to determine the position of a mobile device.

### SUMMARY OF THE INVENTION

According to a first aspect of the present invention, there is provided a method for controlling congestion in sidelink positioning, the method comprising: determining a resource pool allocation for selecting resources; generating at least one parameter based on the resource pool allocation and a past resource selection configuration; configuring a current resource selection for a user device based on the at least one parameter; communicating the current resource selection configuration to the user device for controlling congestion in the allocated resource pool.

Advantageously, the method as described herein can provide metrics and methods for congestion control for sidelink (SL) positioning and can allow congestion control based on a new common metric for positioning and communication in a shared resource pool (RP) while still allowing flexible congestion control between SL positioning and communication. Accordingly, congestion control can be important in SL to avoid overuse of resources by a few UEs.

In an embodiment, the resource pool allocation comprises a shared resource pool allocation or a dedicated resource pool allocation.

In an embodiment, the at least one parameter comprises: sidelink positioning channel occupancy ratio (SL-P CR) associated with a ratio of occupied subchannels to configured subchannels in sidelink positioning transmissions; sidelink positioning received signal strength indicator (SL-P RSSI) associated with a linear average of received power in sidelink positioning transmissions; and sidelink positioning channel busy ratio (SL-P CBR) associated with a ratio of a number of subchannels having SL-P RSSI exceeding a predetermined SL-P RSSI threshold to a total number of configured subchannels.

In an embodiment, the method further includes generating at least one combined parameter, the at least one combined parameter comprising: sidelink shared channel occupancy ratio (SL-Sh CR) associated with sidelink positioning channel occupancy ratio (SL-P CR) and a predetermined weighted score; and sidelink shared channel busy ratio (SL-Sh CBR) associated with sidelink positioning channel busy ratio (SL-P CBR) and the predetermined weighted score.

In an embodiment, the method further includes generating a shared priority value associated with sidelink priority in a shared resource pool; and generating the predetermined weighted score.

In an embodiment, the predetermined weighted score is generated based on at least one of: bandwidth part (BWP), a shared resource pool and/or geographical zone(s).

In an embodiment, the method further includes determining a periodicity of sidelink positioning reference signal (SL PRS); and determining a number of subchannels for sidelink (SL) positioning.

In an embodiment, the method further includes determining a maximum number of sidelink positioning reference signal (SL PRS) and/or measurement (re)transmissions; and determining a maximum SL PRS transmission power.

In an embodiment, the method further includes analyzing the at least one parameter and the at least one combined parameter with a preconfigured threshold limit; and adjusting the periodicity of SL PRS, the number of subchannels for sidelink (SL) positioning, the maximum number of SL PRS and/or the maximum SL PRS transmission power if the parameter and the combined parameter exceeds the preconfigured threshold limit.

In an embodiment, there is provided a computer program comprising instructions which, when the program is executed by a computer, cause the computer to carry out at least one of the at least one of the input step and the processing step according to the method of the first aspect.

In an embodiment, there is provided a computer readable storage medium having data stored therein representing software executable by a computer, the software including instructions, when executed by the computer, to carry out at least one of the input step and the processing step according to the method of the first aspect.

In an embodiment, there is provided a device for controlling congestion in sidelink positioning comprising: a first module configured to obtain data associated with sidelink positioning of a user device; a second module configured to at least one of process and facilitate the method of the first aspect in a first communication mode to generate at least one output signal; and a third module configured to communicate at least one output signal, wherein the output signal corresponds to a control signal for controlling congestion in sidelink positioning.

In an embodiment, the first communication mode comprises controlling channel load in a dedicated resource pool and/or a shared resource pool.

In an embodiment, there is provided an apparatus for controlling congestion in sidelink positioning comprising: a first module configured to obtain data associated with sidelink positioning of a user device; a second module configured to at least one of process and facilitate the method of the first aspect in a second communication mode to generate at least one output signal; and a third module configured to communicate at least one output signal, wherein the output signal corresponds to a control signal for controlling congestion in sidelink positioning.

In an embodiment, the second communication mode comprises modifying transmission parameters to reduce channel load in a dedicated resource pool and/or a shared resource pool.

In an embodiment, the apparatus corresponds to a User Equipment (UE) communicable with a device corresponding to a base station, and wherein the base station corresponds to a Next generation Node B (gNB) configured to communicate the at least one input signal to the UE.

In an embodiment, there is provided a system comprising: at least one apparatus(es); and at least one device(s), wherein the apparatus(es) and the device(s) are capable of being coupled via at least one of wired coupling and wireless coupling.

Advantageously, the system as disclosed herein can have provide suitable metrics for SL positioning congestion control in both shared and dedicated RPs.

Additionally, the metrics and weight parameter for shared RP as disclosed herein can allow flexibility in resource selection prioritization between SL positioning and communication, thereby achieving energy efficiency and power saving in a network.

### BRIEF DESCRIPTION OF THE DRAWINGS

Embodiments of the disclosure are described hereinafter with reference to the following drawings, in which:

FIG. 1A shows a schematic diagram illustrating a system for controlling congestion in sidelink (SL) positioning which can include at least one apparatus, according to an embodiment of the invention.

FIG. 1B to 1D show example scenarios in association with the system of FIG. 1A, according to an embodiment of the invention.

FIG. 2 shows a schematic diagram illustrating the apparatus of FIG. 1A in further detail, according to an embodiment of the invention.

FIG. 3 shows a method in association with the system of FIG. 1A, according to an embodiment of the invention.

### DETAILED DESCRIPTION

The present specification discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the mobile telephone system. The computer program when loaded and executed on such a computer effectively results in an apparatus that implements the steps of the preferred method.

In some embodiments, the non-limiting term user equipment (UE) or wireless device or user device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

In some embodiments, a more general term “network node” may be used and may correspond to any type of radio network node or any network node, which communicates with a user equipment (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

The present disclosure generally contemplates that sidelink (SL) communication can be a communication scheme in which a direct link is established between User Equipments (UEs) and the UEs exchange voice and data directly with each other without intervention of an evolved Node B (eNB). SL communication can be considered as a solution to the overhead of an eNB caused by rapidly increasing data traffic.

The present disclosure also contemplates that Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

The present disclosure further contemplates that as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. A next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

The present disclosure contemplates the possibility that congestion control mechanisms can play an important role in SL communication. However, congestion control for SL positioning may be yet undefined. Suitable metrics and procedures can be defined for SL positioning congestion control in dedicated and shared resource pools (RPs). In a shared RP, sidelink positioning reference signal (SL PRS) transmit power and SL communication channel transmit powers can be different, thereby a new way of comparing the two in computing congestion levels can be provided.

The present disclosure contemplates the possibility of physical layer procedures related to sidelink (SL) positioning. There can be congestion on the resource if UEs transmit unrestrictedly as the wireless resource for SL positioning is shared by several user equipment (UE). Thus, it can be necessary to have some form of congestion control for SL positioning. Accordingly, suitable metrics for measuring congestion in SL positioning in both dedicated and shared resource pools (RPs) and procedures the UE can be provided to mitigate congestion. For shared RPs, new shared metrics can be proposed, while still allowing relative prioritization between congestion due to SL communication and congestion due to SL positioning.

The present disclosure contemplates that there may be existing mechanisms for congestion control in SL communication. Certain new aspects are necessary for congestion control in a shared resource pool (RP) (RP which is used for both SL communication and SL positioning) as there is no concept of a shared RP in SL communication. The present disclosure contemplates a novel way of computing shared congestion control metrics and a unified procedure for both SL positioning and SL communication congestion control, while retaining certain prioritization flexibility between the two.

In the above manner, a method and metrices can be provided for congestion control for SL positioning in both shared and dedicated RPs, in accordance with an embodiment of the invention. In particular, a new shared metric and procedure for congestion control in a shared RP can be provided, which may enable the network to configure unified channel busy ratio ranges and channel occupancy ratio limits for both SL communication and SL positioning. Together with a new weight parameter that can be configured by the network for each shared RP, the network can prioritize between SL positioning and SL communication. Power saving and energy consumption efficiency can therefore possibly be facilitated in the network, in accordance with an embodiment of the invention.

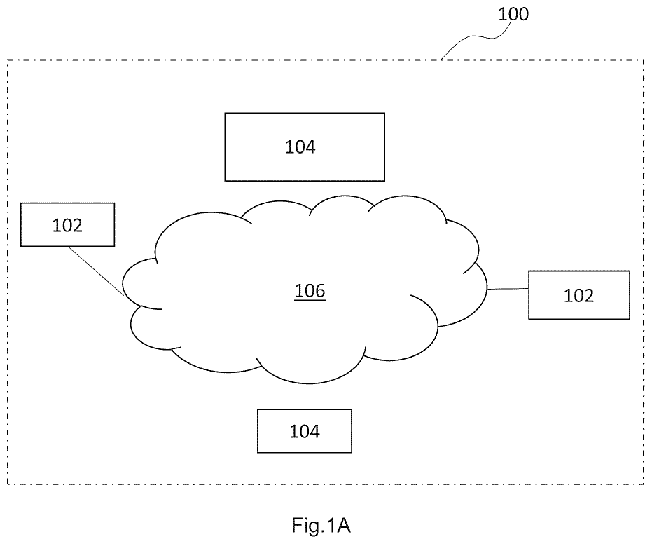

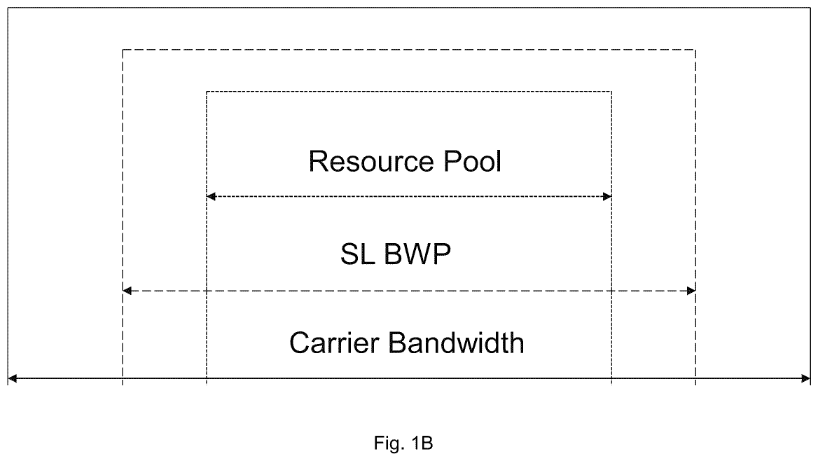

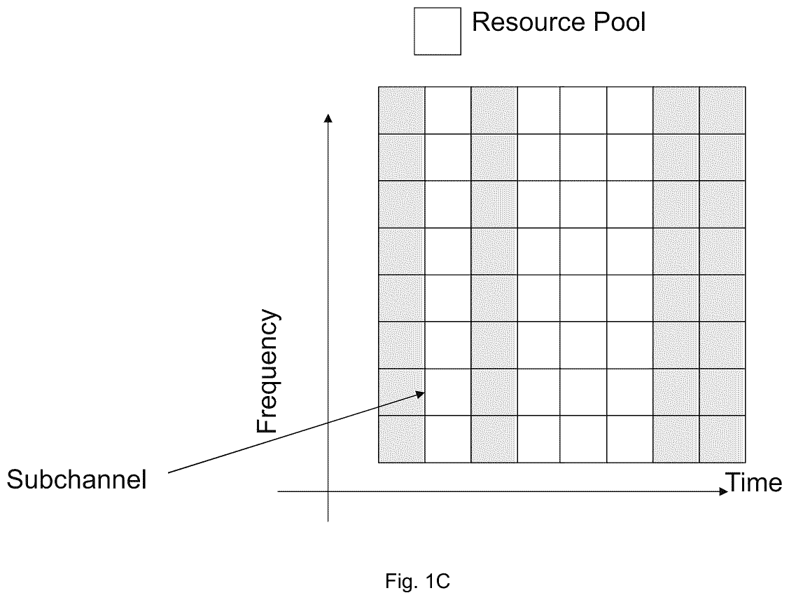

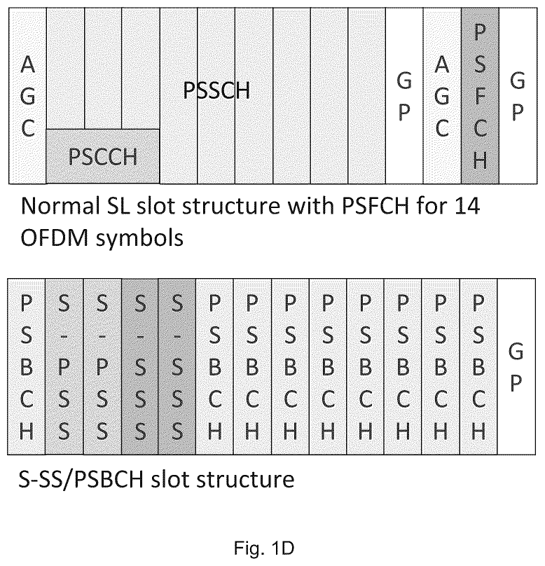

The foregoing will be discussed in further detail with reference to FIG. 1 to FIG. 3 hereinafter.

Referring to FIG. 1A, a schematic diagram illustrating a system 100 for controlling congestion in sidelink positioning is shown, according to an embodiment of the invention. The system 100 can, for example, be suitable for facilitating energy and improve power efficiency, in accordance with an embodiment of the invention.

As shown, the system 100 can include one or more apparatuses 102, at least one device 104 and, optionally, a communication network 106, in accordance with an embodiment of the invention.

The apparatus(es) 102 can be coupled to the device(s) 104. Specifically, the apparatus(es) 102 can, for example, be coupled to the device(s) 104 via the communication network 106, in accordance with an embodiment of the invention.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the invention.

The apparatus(es) 102 can, for example, be associated with or correspond to or include one or more user equipment (UE) which can carry one or more computers, in accordance with an embodiment of the invention. For example, an apparatus 102 can correspond to a UE carrying at least one computer (e.g. an electronic device or module having computing capabilities such as an electronic mobile device which can be carried into a vehicle or an electronic module which can be installed in a vehicle, in accordance with an embodiment of the invention) which can be configured to perform one or more processing tasks in association with adaptive/dynamic/gradual control, in accordance with an embodiment of the invention.

In an embodiment, the apparatus(es) 102 can, for example, be configured to receive one or more input signals and perform at least one processing task based on the input signal(s) in a manner to generate one or more output signals. The input signal(s) can, for example, be communicated from the device(s) 104 and received by the apparatus(es) 102, in accordance with an embodiment of the invention. In an alternate embodiment, the input signal(s) can be communicated from a different apparatus(es) 102 and received by the apparatus(es) 102 and perform at least one processing task based on the input signal(s) in a manner to generate one or more output signals.

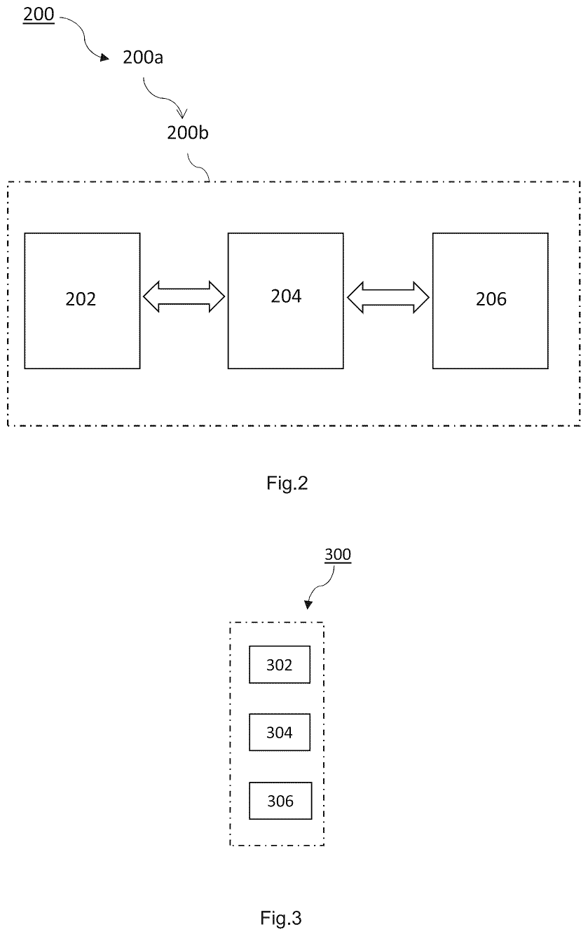

The input signal can be associated with sidelink positioning for a user device (or UE). As a possible option, the output signal(s) can, for example, be communicated from the apparatus(es) 102, in accordance with an embodiment of the invention. The output signal may correspond to a control signal for controlling congestion in sidelink positioning. The apparatus(es) 102 and device(s) 104 will be discussed later in further detail with reference to FIG. 2, according to an embodiment of the invention.

The device(s) 104 can, for example, be associated with/correspond to at least one base station, where the at least one base station can be a Next Generation Node B (gNB). Moreover, the device(s) 104 can, for example, be configured to carry/be associated with/include one or more computers (e.g., an electronic device/module having computing capabilities) which can, for example, be configured to perform one or more processing tasks in association with the base station. The device(s) 104 can be configured to receive one or more input signals which can be communicated from the apparatus(es) 102, in accordance with an embodiment of the invention. The device(s) 104 can, for example, perform one or more processing tasks in association with dynamic/adaptive/gradual control on the input signal(s) in a manner so as to generate at least one output signal. This will be discussed later in further detail in the context of an example scenario, in accordance with an embodiment of the invention.

The communication network 106 can, for example, correspond to an Internet communication network, a cellular-based communication network, a wired-based communication network, a Global Navigation Satellite System (GNSS) based communication network, a wireless-based communication network, or any combination thereof. Communication (e.g., between the apparatuses 102 and/or between the apparatus(es) 102 and the device(s) 104) via the communication network 106 can be by manner of one or both of wired communication and wireless communication.

The device(s) 104 can, for example, be configured to generate at least one input signal and perform at least one processing task in association with dynamic/adaptive/gradual control on the input signal(s) in a manner so as to generate at least one output signal. Moreover, the device(s) 104 can, for example, be configured to generate (and communicate) the output signal(s) to the apparatus(es) 102, in accordance with an embodiment of the invention. Accordingly, the device(s) 104 can generate a control signal for controlling congestion in sidelink positioning to the apparatus(es) 102. This will be discussed, in accordance with an embodiment of the invention, in the context of example scenarios with reference to FIG. 1B to FIG. 1D, hereinafter.

FIG. 1B to 1D show example scenarios in association with the system of FIG. 1A, according to an embodiment of the invention. Specifically, FIG. 1B shows an example of a relationship between Sidelink Bandwidth Part (SL BWP) and a Resource Pool (RP). As shown in the Figure, at most one SL BWP can be configured on a carrier bandwidth such that the configured SL BWP is to be used for both transmitting and receiving Sidelink (SL) signals and channels.

FIG. 1C shows an example of a graph illustrating the relationship between frequency and time in relation to subchannel and resource pool. In an embodiment, a User Equipment (UE or user device) can be configured with one or multiple Sidelink Resource Pools (SL RPs). The time-domain can have minimum granularity one slot and can contain non-contiguous slots while the frequency-domain can have minimum granularity one subchannel (with multiple consecutive Physical Resource Blocks) such that the subchannels must be continuous, in accordance with an embodiment of the invention. In an embodiment, the resource block (RB) may be defined by

$${N}_{sc}^{RB} = 21$$

consecutive subcarriers in the frequency domain while the Common Resource Block (CRB) can be numbered from 0 onwards in the frequency domain for subcarrier spacing configuration μ such that

$${n}_{CRB}^{μ} = ⌊ \frac{k}{{N}_{SC}^{RB}} ⌋ .$$

The physical RB can be defined within the SL BWP and numbered from 0 to

$${N}_{BWP}^{size , μ} - 1.$$

If the SL BWP starts relative to CRB 0, the CRB can be defined by CRB

$${n}_{CRB}^{μ} = \text{?} + \text{?} .$$

$$\text{?} \text{indicates text missing or illegible when filed}$$

FIG. 1D shows two examples of a SL slot structure. As shown in the Figure, the normal slot structure contains physical sidelink control channel (PSCCH), physical sidelink shared channel (PSSCH) and possibly physical sidelink feedback channel (PSFCH) for 14 Orthogonal Frequency Division Multiplexing (OFMD) symbols. The sidelink synchronization signal block (S-SSB) may contain sidelink synchronization signals (S-SS) and physical sidelink broadcast channel (PSBCH).

In an example embodiment, sidelink received signal strength indicator (SL RSSI) can be defined as the linear average of the total received power (in Watts W) observed in the configured sub-channel in OFDM symbols of a slot configured for PSCCH and PSSCH, starting from the second OFDM symbol. For frequency range 1, the reference point for the SL RSSI can be the antenna connector of the UE (or user device). For frequency range 2, SL RSSI can be measured based on the combined signal from antenna elements corresponding to a given receiver branch. For both frequency range 1 and 2, if receiver diversity is in use by the UE, the reported SL RSSI may not be lower than the corresponding SL RSSI of any of the individual receiver branches. SL RSSI may be applicable for radio resource control (RRC) such as RRC_IDLE intra-frequency, RRC_IDLE inter-frequency, RRC_CONNECTED intra-frequency and RRC_CONNECTED inter-frequency.

In an embodiment, sidelink channel occupancy ratio (SL CR) evaluated at slot n may be defined as the total number of sub-channels used for its transmissions in slots [n−a, n−1] and granted in slots [n, n+b] divided by the total number of configured sub-channels in the transmission pool over [n−a, n+b]. SL CR may related to own transmissions and may be computed for each priority value. It may be applicable for radio resource control (RRC) such as RRC_IDLE intra-frequency, RRC_IDLE inter-frequency, RRC_CONNECTED intra-frequency and RRC_CONNECTED inter-frequency. In addition, SL CR and its parameters may be subject to conditions or restrictions given in table 1 below.

TABLE 1
SL CR conditions and restrictions

| | |
|---|---|
| NOTE 1: | a is a positive integer and b is 0 or a positive integer; a and b are determined by UB implementation with |
| | a + b + 1 = 1000 or 1000 · 2^{μ} slots, according to higher layer parameter sl-TimeWindowSizeCR, b < |
| | (a + b + 1)/2, and n + b shall not exceed the last transmission opportunity of the grant for the current |
| | transmission. |
| NOTE 2: | SL CR is evaluated for each (re)transmission. |
| NOTE 3: | In evaluating SL CR, the UE shall assume the transmission parameter used at slot n is reused according |
| | to the existing grant(s) in slot [n + 1, n + b] without packet dropping. |
| NOTE 4: | The slot index is based on physical slot index. |
| NOTE 5: | SL CR can be computed per priority level |
| NOTE 6: | A resource is considered granted if it is a member of a selected sidelink grant as defined in TS 38.321 [7]. |

In an embodiment, sidelink channel busy ratio (SL CBR) may relate to other UE (or user device) transmissions and can be applicable and defined in table 2 below.

TABLE 2
SL CBR definition and application

| | |
|---|---|
| Definition | SL Channel Busy Ratio (SL CBR) measured in slot n is defined as the portion of sub-channels in |
| | the resource pool whose SL RSSI measured by the UE exceed a (pre-)configured threshold |
| | sensed over a CBR measurement window [n-a, n-1]. wherein a is equal to 100 or 100 · 2^{μ} slots, |
| | according to higher layer parameter sl-TimeWindowSizeCBR. When UE is configured to perform |
| | partial sensing by higher layers (including when SL DRX is configured), SL RSSI is measured in |
| | slots where the UE performs partial sensing and where the UE performs PSCCH/PSSCH |
| | reception within the CSR measurement window. The calculation of SL CBR is limited within the |
| | slots for which the SL RSSI is measured. If the number of SL RSSI measurement slots within the |
| | CBR measurement window is below a (pre-)configured threshold, a (pre-)configured SL CBR |
| | value is used. |
| Applicable for | RRC_IDLE intra-frequency, |
| | RRC_IDLE inter-frequency. |
| | RRC_CONNECTED intra-frequency. |
| | RRC_CONNECTED Inter-frequency |

In an example embodiment, the base station or gNB may control channel load in a first communication mode. In this mode, it can request each UE to report (periodically or on demand) its measured CBR. In another embodiment, the transmitting (TX) UE may use measured SL CBR and SL CR to identify whether it should modify its transmission parameters to reduce channel load in a second communication mode. This can be achieved using a (pre-)configured lookup table that includes up to 16 CBR ranges, where each range may be linked with maximum SL CR (sl-CR-Limit) that the TX UE cannot surpass. The sl-CR-Limit may be increased as the CBR range decreases and the value of sl-CR-Limit for each CBR range can be a function of priority of transmission block (TB) and absolute speed of the TX UE. The TX UE can also evaluate whether it is exceeding the sl-CR-Limit and may modify its transmission parameters at each (re-)transmission. This is so that SL CR can be reduced and the channel load generated by the TX UE can be controlled.

In an example embodiment, the TX UE can modify following the PSCCH/PSSCH transmission parameters per resource pool (RP) for congestion control. An example transmission parameter is modulation coding scheme (MCS) range, where channel load can be reduced by using higher order MCS which reduces number of subchannels necessary to transmit TB. Another example transmission parameter is the number of subchannels where the UE (or user device) can reduce its CR by limiting the number of sub-channels it can utilize. A further example of transmission parameter can be the maximum number of retransmissions, where the UE can reduce its CR by limiting the number of (re-)transmissions. Another example of transmission parameter is the maximum transmission power, where the UE can decrease CBR by reducing its transmission power and if the CBR decreases to values within lower CBR ranges, the UE can utilize higher sl-CR-Limit.

In an embodiment, if a UE (or user device) is configured with higher layer parameter sl-CR-Limit and transmits PSSCH in slot n, the UE (or user device) may ensure the following limits is satisfied for any priority value k, Σ_{t≥k}CR(i)≤CR_{Limit}(k), where CR(i) is the CR evaluated in slot n−N for the PSSCH transmissions with ‘Priority’ field in the sidelink control information (SCI) set to i, and CR_{Limit}(k) corresponds to the high layer parameter sl-CR-Limit that is associated with the priority value E and the CBR range which includes the CBR measured in slot n−N, where N is the congestion control processing time. In this embodiment, the congestion control processing time N can based on μ, as shown in Table 3 and Table 4 below, for UE (or user device) processing capability 1 and 2 respectively, where μ corresponds to the subcarrier spacing of the sidelink channel with which the PSSCH is to be transmitted. The UE (or user device) may only apply a single processing time capability in sidelink congestion control.

TABLE 3
Congestion Control processing time for processing timing capability 1

| μ | Congestion control processing time N [slots] |
|---|---|
| 0 | 2 |
| 1 | 2 |
| 2 | 4 |
| 3 | 8 |

TABLE 4
Congestion Control processing time for processing timing capability 2

In an example embodiment, SL-CBR-PriorityTxConfigList information element and its field description can be provided in tables 5 and 6 below. Specifically, tables 5 and 6 may indicate the mapping between PSSCH transmission parameter (such as MCS, PRB number, retransmission number, CR limit etc.) sets by using the indexes of the configurations provided in sl-CBR-PSSCH-TxConfigList, CBR ranges by an index to the entry of the CBR range configuration in sl-CBR-RangeConfigList, and priority ranges. It may also indicate the default PSSCH transmission parameters to be used when CBR measurement results are not available, and MCS range for the MCS tables used in the resource pool.

TABLE 5
SL-CBR-PriorityTxConfigList information element

-- ASN1START

[symbol]

SL-CBR-PriorityTxConfigList-r16 ::= SEQUENCE (SIZE (1..8)) OF SL-PriorityTxConfigIndex-r16
SL-CBR-PriorityTxConfigList-v16 [symbol] ::= SEQUENCE (SIZE (1..8)) OF SL-PriorityTxConfigIndex-v16

[symbol]

| SL-PriorityTxConfigIndex-r16 ::= | SEQUENCE { | |
|---|---|---|
| sl-PriorityThreshold-r16 | INTEGER (1..8) | OPTIONAL, -- Need [symbol] |
| sl-DefaultTxConfigIndex-r16 | INTEGER (0..maxCBR-Level-1-r16) | OPTIONAL, -- Need [symbol] |
| sl-CBR-ConfigIndex-r16 | INTEGER (0..maxCBR-Config-1-r16) | OPTIONAL, -- Need [symbol] |
| sl-Tx-ConfigIndexList-r16 | SEQUENCE (SIZE (1.. maxCBR-Level-r16)) OF SL-TxConfigIndex-r16 | OPTIONAL -- Need [symbol] |

}

| SL-PriorityTxConfigIndex-v16 [symbol] ::= | SEQUENCE { | |
|---|---|---|
| sl-MCS-RangeList-r16 | SEQUENCE (SIZE (1..maxCBR-Level-r16)) OF SL- [symbol] MSC-List-r16 | OPTIONAL -- Need [symbol] |

}

| | |
|---|---|
| SL-TxConfigIndex-r1 [symbol] ::= | INTEGER (0..maxTxConfig-1-r16) |

[symbol]

-- ASN1STOP [symbol]
indicates data missing or illegible when filed

TABLE 6
SL-CBR-PriorityTxConfigList field description
SL-CBR-PriorityTxConfigList field descriptions

sl-CBR-ConfigIndex
Indicates the CBR ranges to be used by an index to the entry of the CBR range configuration
in sl-CBR-RangeConfigList.
sl-DefaultTxConfigIndex

[symbol]

✓ [symbol]
indicates data missing or illegible when filed

In an example embodiment, SL-CBR-CommonTxConfigList information element and its field description can be provided in tables 7 and 8 below. Specifically, tables 7 and 8 may indicate the list of PSSCH transmission parameters (such as MCS, sub-channel number, retransmission number, CR limit etc.) in sl-CBR-PSSCH-TxConfigList, and the list of CBR ranges in sl-CBR-RangeConfigList, in order to configure congestion control to the UE (or user device) for sidelink communication.

TABLE 7
SL-CBR-CommonTxConfigList information element

-- ASN1START

[symbol]

| SL-CBR-CommonTxConfigList-r16 ::= | SEQUENCE { | |
|---|---|---|
| sl-CBR-RangeConfigList-r16 | SEQUENCE (SIZE (1..maxCBR-Config-r16)) OF SL-CBR-LevelsConfig-r16 | OPTIONAL, -- Need [symbol] |
| sl-CBR-PSSCH-TxConfigList-r16 | SEQUENCE (SIZE 1.. maxTxConfig-r16)) OF SL-CBR-PSSCH-TxConfig-r16 | OPTIONAL -- Need [symbol] |

}

| SL-CBR-LevelsConfig-r16 ::= | SEQUENCE (SIZE (1..maxCBR-Level-r16)) OF SL-CBR-r16 | |
|---|---|---|
| SL-CBR-PSSCH-TxConfig-r16 ::= | SEQUENCE { | |
| sl-CR- [symbol] -r16 | INTEGER(0..10000) | OPTIONAL, -- Need [symbol] |
| sl-TxParameters-r16 | SL-PSSCH-TxParameters-r16 | OPTIONAL -- Need [symbol] |

}

| | |
|---|---|
| SL-CBR-r1 [symbol] ::= | INTEGER (0..100) |

[symbol]

-- ASN1STOP [symbol]
indicates data missing or illegible when filed

TABLE 8
SL-CBR-CommonTxConfigList field description
SL-CBR-CommonTxConfigList field descriptions

sl-CBR-RangeConfigList
Indicates the list of CBR ranges. Each entry of the list indicates in SL-CBR-LevelsConfig the upper bound of the CBR range for the
respective entry. The upper bounds of the CBR ranges are configured in ascending order for consecutive entries of sl-CBR-RangeConfigList.
For the first entry of sl-CBR-RangeConfigList the lower bound of the CBR range is 0. Value 0 corresponds to 0, value 1 to 0.01,
value 2 to 0.02, and so on.
sl-CR-Limit
Indicates the maximum limit on the occupancy ratio. Value 0 corresponds to 0, value 1 to 0.0001, value 2 to 0.0002, and so on (i.e. in steps
of 0.0001) until value 10000, which corresponds to 1.
sl-CBR-PSSCH-TxConfigList
Indicates the list of available PSSCH transmission parameters (such as MCS, sub-channel number, retransmission number and CR limit) configurations.
sl-TxParameters
Indicates PSSCH transmission parameters.

The present disclosure contemplates that in scheme 2 of SL PRS resource allocation associated with 3GPP Radio Access Network (RAN) expanded and improved new radio (NR) positioning Release 18, the following aspects can be considered, for example resource selection mechanism for SL PRS, inter-UE coordination and aspects for congestion control mechanisms for SL PRS.

In an example embodiment, the following options can be considered in 3GPP RAN expanded and improved new radio (NR) positioning Release 18 related to multiplexing of other channels in a dedicated resource pool for SL positioning in addition to SL PRS. A first option may consider the possibility that no other channel can be includes beyond SL PRS. A second option may consider the possibility that PSCCH which carries SCI associated with SL PRS transmission(s) is included. A third option may consider the possibility that both PSCCH which carries SCI associated with SL PRS transmission(s) and PSCCH associated with SL PRS transmission(s) are included, where PSCCH associated with SL PRS transmission(s) may be considered and further evaluated.

The above-described aspect(s) of the system 100 of the present invention can also apply analogously (all) the aspect(s) of a below described apparatus 102 and device 104 of the present invention. Likewise, all below described aspect(s) of the apparatus 102 and device 104 of the invention can also apply analogously (all) the aspect(s) of above-described system 100 of the invention.

The aforementioned apparatus(es) 102 or User Equipment (UE) will be discussed in further detail with reference to FIG. 2 hereinafter.

Referring to FIG. 2, a schematic diagram illustrating an apparatus 102 is shown in further detail in the context of an example implementation 200, according to an embodiment of the invention.

In the example implementation 200, the apparatus 102 can correspond to an electronic module 200a. The electronic module 200a can, in one example, correspond to a mobile device which can, for example, be carried into the vehicle by a user, in accordance with an embodiment of the invention. In another example, the electronic module 200a can correspond to an electronic device which can be installed/mounted in the vehicle, in accordance with an embodiment of the invention. In this regard, the electronic module 200a can be considered to be carried by the vehicle (e.g., either carried into the vehicle by a user or installed/mounted in the vehicle).

It is contemplated that the electronic module 200a can be capable of performing one or more processing tasks in association with adaptive/dynamic/gradual control related processing, in accordance with an embodiment of the invention.

The electronic module 200a can, for example, include a casing 200b. Moreover, the electronic module 200a can, for example, carry any one of a first module 202, a second module 204, a third module 206, or any combination thereof.

In one embodiment, the electronic module 200a can carry a first module 202, a second module 204 and/or a third module 206. In a specific example, the electronic module 200a can carry a first module 202, a second module 204 and a third module 206, in accordance with an embodiment of the invention.

In this regard, it is appreciable that, in one embodiment, the casing 200b can be shaped and dimensioned to carry any one of the first module 202, the second module 204 and the third module 206, or any combination thereof.

The first module 202 can be coupled to one or both of the second module 204 and the third module 206. The second module 204 can be coupled to one or both of the first module 202 and the third module 206. The third module 206 can be coupled to one or both of the first module 202 and the second module 204. In one example, the first module 202 can be coupled to the second module 204 and the second module 204 can be coupled to the third module 206, in accordance with an embodiment of the invention. Coupling between the first module 202, the second module 204 and/or the third module 206 can, for example, be by manner of one or both of wired coupling and wireless coupling. Each of the first module 202, the second module 204 and the third module 206 can correspond to one or both of a hardware-based module and a software-based module, according to an embodiment of the invention.

In one example, the first module 202 can correspond to a hardware-based receiver which can be configured to receive one or more input signals. The input signal(s) can, for example, be communicated from the device(s) 104 (or base station e.g., a gNB), in accordance with an embodiment of the invention.

The second module 204 can, for example, correspond to a hardware-based processor which can be configured to perform one or more processing tasks (e.g., in a manner so as to generate one or more output signals) as will be discussed later in further detail with reference to FIG. 3, in accordance with an embodiment of the invention.

The third module 206 can correspond to a hardware-based transmitter which can be configured to communicate one or more output signals from the electronic module 200a. The output signal(s) can, for example, include one or more instructions/commands/control signals in association with the aforementioned dynamic/adaptive/gradual control configuration/determination strategy so as to facilitate efficiency (e.g., power/energy efficiency and/or communication efficiency), in accordance with an embodiment of the invention. For example, the output signal(s) can be a control signal(s) to control congestion in sidelink positioning by a user device (or UE).

The present disclosure contemplates the possibility that the first and second modules 202, 204 can be an integrated software-hardware based module, for example, an electronic part which can carry a software program or algorithm in association with receiving and processing functions or an electronic module programmed to perform the functions of receiving and processing. The present disclosure further contemplates the possibility that the first and third modules 202, 206 can be an integrated software-hardware based module, for example an electronic part which can carry a software program or algorithm in association with receiving and transmitting functions or an electronic module programmed to perform the functions of receiving and transmitting. The present disclosure yet further contemplates the possibility that the first and third modules 202, 206 can be an integrated hardware module, for example a hardware-based transceiver, capable of performing the functions of receiving and transmitting.

The apparatus 102 (or UE) can, for example, be further configured to process the input signal(s), as will be discussed later in further detail with reference to FIG. 3, in a manner so as to generate one or more output signals in a manner so as to facilitate efficiency, for example power efficiency or energy efficiency, in accordance with an embodiment of the invention. In one specific example, the output signal(s) can include one or more control signals to facilitate some form of dynamic/adaptive/gradual control configuration/determination strategy so as to facilitate efficiency, for example power efficiency or energy efficiency, in accordance with an embodiment of the invention. For example, the output signal(s) can be a control signal(s) for controlling congestion in sidelink positioning by the user device (or UE).

In an alternative embodiment, the schematic diagram of FIG. 2 may illustrate a device 104 in the context of the example implementation 200, according to an embodiment of the invention.

In particular, the example implementation 200 together with its modules 200a, 200b, 202, 204 and 206 as described above may correspond to a device 104 such as a base station (or gNB). For example, the electronic module 200a having the casing 200b, the first module 202, the second module 204 and the third module 206 may be installed in a base station (or gNB). In an example, the first module 202 can correspond to a hardware-based receiver which can be configured to receive one or more input signals which can, for example, be communicated from the apparatus 102 (or UE or user device), in accordance with an embodiment of the invention.

The device 104 (or base station) can, for example, be further configured to process the input signal(s), as will be discussed later in further detail with reference to FIG. 3, in a manner so as to generate one or more output signals in a manner so as to facilitate efficiency, for example power efficiency or energy efficiency, in accordance with an embodiment of the invention. In one specific example, the output signal(s) can include one or more control signals to facilitate some form of dynamic/adaptive/gradual control configuration/determination strategy so as to facilitate efficiency, for example power efficiency or energy efficiency, in accordance with an embodiment of the invention. For example, the output signal(s) can be a control signal(s) for controlling congestion in sidelink positioning by the user device (or UE).

The above-described aspect(s) of the apparatus 102 and device 104 of the present invention can also apply analogously (all) the aspect(s) of a below described processing/communication method of the present invention. Likewise, all below described aspect(s) of the method of the invention can also apply analogously (all) the aspect(s) of above described apparatus 102 and device 104 of the invention. It is to be appreciated that these remarks apply analogously to the earlier discussed system 100 of the present disclosure.

Referring to FIG. 3, a method 300 (or a communication method) for controlling congestion in association with the system 100 is shown, according to an embodiment of the invention.

The method 300 can, for example, be suitable for facilitating energy efficiency, network optimization and power saving in accordance with an embodiment of the invention.

The method 300 can include any one of an input step 302, a processing step 304 and an output step 306, or any combination thereof, in accordance with an embodiment of the invention.

In an embodiment, the processing method 300 can include the input step 302. In another embodiment, the processing method 300 can include the input step 302 and the processing step 304. In another embodiment, the processing method 300 can include the input step 302, the processing step 304 and the output step 306. In yet another embodiment, the processing method 300 can include the processing step 304 and one or both of the input step 302 and the output step 306. In yet a further embodiment, the processing method 300 can include the input step 302, the processing step 304 and the output step 306. In yet a further additional embodiment, the processing method 300 can include the processing step 304. In yet another further additional embodiment, the processing method 300 can include any one of or any combination of the input step 302, the processing step 304 and the output step 306 (i.e., the input step 302, the processing step 304 and/or the output step 306).

With regard to the input step 302, one or more input signal(s) can be received. For example, the input signal(s) can be communicated from the device 104 and can be received by the apparatus 102, in accordance with an embodiment of the invention. In an alternative embodiment, the input signal(s) can be generated and communicated from a different apparatus 102.

The input step 302 can include receiving at least one input signal associated with sidelink positioning for a user device (or UE). In an embodiment, the input signal(s) may be generated by the device 104 and transmitted from the device 104 to the apparatus 102. Alternatively, the input signal(s) may be generated and received by the apparatus 102 to advance to the processing step 304. For example, the input signal(s) may be generated by a transmitting UE (or user device) and received by a receiving UE (or user device).

With regard to the processing step 304, at least a processing task can be performed in association with the received input signal(s) in a manner so as to generate one or more output signals, in accordance with an embodiment of the invention.

The processing step 304 may include at least one of: determining a resource pool allocation for selecting resources; generating at least one parameter based on the resource pool allocation and a past resource selection configuration; configuring a current resource selection for a user device based on the at least one parameter; communicating the current resource selection configuration to the user device for controlling congestion in the allocated resource pool. The resource pool allocation includes a shared resource pool allocation or a dedicated resource pool allocation. The at least one parameter can include sidelink positioning channel occupancy ratio (SL-P CR) associated with a ratio of occupied subchannels to configured subchannels in sidelink positioning transmissions; sidelink positioning received signal strength indicator (SL-P RSSI) associated with a linear average of received power in sidelink positioning transmissions; and sidelink positioning channel busy ratio (SL-P CBR) associated with a ratio of a number of subchannels having SL-P RSSI exceeding a predetermined SL-P RSSI threshold to a total number of configured subchannels.

In a specific embodiment, the UE (or user device) may compute a new metric called sidelink positioning channel occupancy ratio (SL-P CR) which gives the ratio of subchannels occupied by the UE (or user device) to the resources granted for SL positioning in a (pre-)configured measurement window, whereby the SL-P CR is computed for each SL positioning priority value. SL-P CR may be applicable to the dedicated resource pool or shared resource pool and may be evaluated at slot n. SL-P CR can be computed by the total number of subchannels used for SL positioning related transmissions in slots [n−a′, n−1] and granted for SL positioning related transmissions in slots [n, n+b′] divided by total number of configured sub-channels for SL positioning related transmissions in transmission pool over [n−a′, n+b′], where a is a positive integer and b is 0 or a positive integer; a and b may be determined by the UE (or user device) implementation with specified by suitable higher layer parameter(s). Further, SL-P CR can be evaluated for each (re-)transmission and can be computed per SL positioning priority level.

In another specific embodiment, the UE (or user device) may also compute a new metric called sidelink positioning received signal strength indicator (SL-P RSSI) which is the linear average of the received power in the orthogonal frequency-division multiplexing (OFDM) symbols of a slot that are used for SL positioning related transmissions. SL-P RSSI may be applicable to the dedicated resource pool or the shared resource pool. Specifically, SL-P RSSI can be the linear average of total received power (in [W]) observed in sub-channel configured for SL positioning for this UE in OFDM symbols of a slot, computed over the OFDM symbols that are used for SL positioning related transmissions only.

In yet another specific embodiment, the UE (or user device) may also compute a new metric called sidelink positioning channel busy ratio (SL-P CBR) which gives the ratio of the number of subchannels with SL-P RSSI larger than a (pre-)configured threshold to the number of granted subchannels to the UE (or user device) for SL positioning in the (pre-)configured measurement window. SL-P CBR may be applicable to the dedicated resource pool or the shared resource pool and may be measured in slot n. SL-P CBR may include a portion of sub-channels in RP whose SL-P RSSI measured by the UE (or user device) exceed a (pre-)configured threshold sensed over a SL-P CBR measurement window [n−a′, n−1], wherein a′ is (pre-)configured according to higher layer parameter(s).

The processing step 304 may further include generating at least one combined parameter. The at least one combined parameter can include sidelink shared channel occupancy ratio (SL-Sh CR) associated with sidelink positioning channel occupancy ratio (SL-P CR) and a predetermined weighted score; and sidelink shared channel busy ratio (SL-Sh CBR) associated with sidelink positioning channel busy ratio (SL-P CBR) and the predetermined weighted score. The processing step 304 may further include generating a shared priority value associated with sidelink priority in a shared resource pool; and generating the predetermined weighted score. The predetermined weighted score is generated based on at least one of: bandwidth part (BWP), a shared resource pool and/or geographical zone(s).

In a specific embodiment, SL-Sh CR may be applicable to shared RP only and may configure a+b+1=a′+b′+1 (i.e., same measurement time window for both SL positioning and communication). In this embodiment, each UE (or user device) i can choose any (aₜ, bₜ) and

$$( {a}_{i}^{′} , {b}_{i}^{′} )$$

pairs such that

$$\text{?} + \text{?} + 1 = \text{?} + \text{?} + 1$$

$$\text{?} \text{indicates text missing or illegible when filed}$$

for each i. Then SL-Sh CR=ω·SL-P CR+(1−ω)·SL-P CR, where 0<ω<1 can be a new (pre-) configured weight parameter (or weighted score). In addition, SL-Sh CR can be computed per shared priority level. The shared priority level can be derived as [ω·SL Pos. priority+(1−ω)·(SL Comm. Priority)]. Alternatively, the shared priority level can be (pre)configured by a mapping table, for example table 9 shown below.

TABLE 9
Shared priority level mapping table

| SL comm. | SL pos. | SL Shared |
|---|---|---|
| priority | priority | priority |
| [symbol] | [symbol] | 1 |
| [symbol] | [symbol] | 2 |
| [symbol] | [symbol] | [symbol] |
| [symbol] | [symbol] | [symbol] |

[symbol]

indicates data missing or illegible when filed

In a further specific embodiment, SL-Sh CBR may be applicable to shared RP only and may configure a=a′ for all UEs (or user devices) in the same RP (i.e., same measurement window). Then SL-Sh CBR=ω·SL-P CBR+(1−ω)·SL-P CBR, where 0<ω<1, which can be a new (pre-) configured weight parameter (or weighted score). Further, SL-Sh CBR can be computed per shared priority level.

In a further specific embodiment, the weight parameter (or weighted score) may be configured per bandwidth part (BWP) or per shared RP or per geographical zone or any combination of these by the network (or base station or gNB). The weight parameter (or weighted score) can be indicated by the network when assigning the shared RPs to UEs or user devices (parameter associated with RP).

This can include the possibility of dynamic indication via system information message. In the case of dynamic indication, in-coverage UEs (or user devices) may forward the indication to out-of-coverage UEs (or user devices). The network (or base station or gNB) can use weight parameter d to control the congestion levels of SL positioning and/or SL communication in a shared RP. For example, If ω≈1, then SL positioning part in shared congestion metrics have higher weightage, i.e., SL communication is preferred to have less congested operation. On the other hand, if ω≈0, then SL communication part in shared congestion metrics have higher weightage, i.e., SL positioning is preferred to have less congested operation.

The processing step 304 may further include analyzing the at least one parameter and the at least one combined parameter with a preconfigured threshold limit; and adjusting the periodicity of SL PRS, the number of subchannels for sidelink (SL) positioning, the maximum number of SL PRS and/or the maximum SL PRS transmission power if the parameter and the combined parameter exceeds the preconfigured threshold limit.

In an embodiment, two options for congestion control in a shared resource pool (RP) are contemplated as resources can be granted for both SL communication and SL positioning, and the new metrics (SL-P CR and SL-P CBR) and other metrics (SL CR and SL CBR) may be first computed separately by the UE (or user device). The first option may include the possibility that the network (or base station or gNB) provides the UE (or user device) with the weight parameter ω indicating weightage to be given to SL positioning and SL communication metrics. The UE (or user device) may then compute the new combined metric SL-Sh CBR by combining SL-P CBR and SL CBR using the relation: [symbol] . For example, if weight parameter is E.g., if weight parameter is ω=25%, then and SL-Sh CBR=(25%)·SL-P CBR+(75%)·SL-P CBR.

The UE (or user device) computes/obtains a shared priority value i_{shared} and for each slot using one of the two methods. The first method includes the formula i_{shared}=┌ω·iₚₒₛ+(1−ω)·i_{comm}┐, where iₚₒₛ can be the SL positioning priority value in the slot and i_{comm} can be the SL communication priority value in the slot. For example, if ω=0.5, iₚₒₛ=2 and i_{comm}=3, i_{shared}=┌1+1.5┐=3. In the second method, i_{shared} can be determined by a (pre-)configured table provided by the network for the RP.

The UE (or user device) may further compute a new combined metric SL-Sh CR for each shared priority value using the relation:

$$SL - Sh CR = ω SL - P CR + ( 1 - ω ) SL CR$$

For each shared priority value, the UE (or user device) checks if the sum of SL-Sh CR values for this priority value and all other higher priority values present in the slots in the measurement window is less than or equal to the SL-Sh CR limit provided by a higher layer parameter, i.e., for each shared priority level k, the UE (or user device) checks the condition:

$$\text{?} SL - Sh CR ( i ) \leq SL - Sh C \text{?} ( k )$$

$$\text{?} \text{indicates text missing or illegible when filed}$$

If the above condition is satisfied, the UE (or user device) transmits in the slot in the shared RP with the current chosen parameters for SL positioning and SL communication. If the above condition is not satisfied, the UE (or user device) adjusts any of the controllable parameters according to the configuration table(s) provided by higher layers. The controllable parameters can include the periodicity of SL PRS, the number of subchannels for sidelink (SL) positioning, the maximum number of SL PRS and/or the maximum SL PRS transmission power

The second option for congestion control in the shared RP may include the possibility that instead of computing shared metrics, the UE (or user device) retains separate metrics for positioning and communication. The UE (or user device) can follow the above-described procedures separately for positioning and communication. If conditions on both SL-P CR limit and SL CR limit are met, the UE (or user device) continues with SL positioning and SL communication transmissions without changing any parameters. On the other hand, if the condition on SL-P CR limit is not met, the UE (or user device) adjusts any of the controllable parameters for SL positioning according to the configuration table(s) provided by higher layers.

In an embodiment, congestion control in a dedicated resource pool (RP) can include the possibility that only SL-P CR and SL-P CBR are computed as all resources are granted for SL positioning purposes. SL-P CR may be computed for each positioning priority level and the network (or base station or gNB) configures SL-P CBR ranges at MAC layer and associates SL-P CR limit for each range and each positioning priority level. For each priority level, the UE (or user device) checks if the sum of SL-P CRs for this priority level and all higher priority levels are not greater than SL-P CR limit for this priority level. If the condition on SL-P CR limit is met, the UE (or user device) continues with SL positioning transmissions without changing any parameters. On the other hand, if the condition on SL-P CR limit is not met, the UE (or user device) adjusts any of the controllable parameters for SL positioning according to the configuration table(s) provided by higher layers.

The processing step 304 may further include determining a periodicity of sidelink positioning reference signal (SL PRS); determining a number of subchannels for sidelink (SL) positioning; determining a maximum number of sidelink positioning reference signal (SL PRS) and/or measurement (re)transmissions; and determining a maximum SL PRS transmission power.

In a specific embodiment, a transmitting (TX) UE can modify the following SL positioning related transmission parameters in a dedicated or shared RP for congestion control. An example parameter includes a periodicity of sidelink positioning reference signal (SL PRS), where the UE (or user device) can decrease the SL-P CR and/or the SL-Sh CR by increasing the time period for periodic SL PRS transmissions. Another example parameter includes a number of subchannels for SL positioning where the UE (or user device) can reduce its SL-P CR and/or SL-Sh CR by limiting the number of sub-channels it can utilize for SL positioning. A further example parameter includes a maximum number of SL PRS or measurement report (re-)transmissions, where the UE (or user device) can reduce its SL-P CR an/or SL-Sh CR by limiting the number of SL PRS or other SL positioning related (re-)transmissions. Another example parameter includes a maximum SL PRS transmission power where the UE (or user device) can decrease SL-P CR and/or SL-Sh CR by reducing its transmission power.

With regards to the output step 306, the output signal(s) can, for example, be communicated from the apparatus 102, as an option, in accordance with an embodiment of the invention. In an example embodiment, the output signal(s) can optionally be communicated from the device 104. In a more specific example, the output signal(s) can optionally be communicated from the device 104 to one or both of the apparatus(es) 102, in accordance with an embodiment of the invention. The apparatus 102 (or UE or user device) may also perform the input step 302, the processing step 304 and the output step 306, in accordance with an example embodiment of the invention.

The present disclosure further contemplates a computer program (not shown) which can include instructions which, when the program is executed by a computer (not shown), cause the computer to carry out the input step 302, the processing step 304 and/or the output step 306 as discussed with reference to the method 300. For example, the computer program can include instructions which, when the program is executed by a computer, cause the computer to carry out the input step 302 and/or the processing step 304, in accordance with an embodiment of the invention.

The present disclosure yet further contemplates a computer readable storage medium (not shown) having data stored therein representing software executable by a computer (not shown), the software including instructions, when executed by the computer, to carry out the input step 302, the processing step 304 and/or the output step 306 as discussed with reference to the method 300. For example, the computer readable storage medium can have data stored therein representing software executable by a computer, the software including instructions, when executed by the computer, cause the computer to carry out the input step 302 and/or the processing step 304, in accordance with an embodiment of the invention.

Further in view of the foregoing, it is appreciable that the present disclosure generally contemplates an apparatus 102 and/or a device 104 for controlling congestion in sidelink positioning which can include a first module 202, a second module 204 and/or a third module 206.

The first module 202 can be configured to receive one or more input signals. The input signal(s) can, for example, be associated with sidelink positioning of a user device.

The second module 204 can be configured to process and/or facilitate processing of the input signal(s) according to the method 300 as discussed earlier to generate one or more output signals in a first communication mode or a second communication mode. The first communication mode may include controlling channel load in a dedicated resource pool and/or a shared resource pool. The second communication mode may include modifying transmission parameters to reduce channel load in a dedicated resource pool and/or a shared resource pool.

In an example embodiment, the first communication mode (or scheme one) for resource allocation can include controlling of the channel load by the gNB (or base station) in both dedicated and shared RPs by requesting each UE (or user device) to report its measured CBRs, e.g. SL-P CBR in dedicated RP and SL-Sh CBR in shared RP, either periodically or on demand.

In another example embodiment, the second communication mode (or scheme 2) for resource allocation can include using measured values by the transmitting (TX) UE (or user device) to identify whether it should modify its SL positioning/communication transmission parameters to reduce channel load. This can be done using a (pre-)configured lookup table, for example different table(s) for dedicated and shared RP(s), for SL-P CBR (for dedicated RP) and SL-Sh CBR (for shared RP) ranges. Each of the ranges can be linked with maximum SL-P CR (for dedicated RP) or SL-Sh CR (for shared RP) that the TX UE (or user device) cannot surpass, where the maximum SL-P CR (or SL-Sh CR) can increase as SL-P CBR (or SL-Sh CBR) range decreases. Subsequently, the TX UE (or user device) can evaluate whether it is exceeding the maximum SL-P CR (or SL-Sh CR) and may modify its transmission parameters at each (re-)transmission. In addition, each UE (or user device) may ensure that Σ_{t≥k}SL-Sh CR(i)≤(SL-Sh CR)_{Limit}(k) for any shared priority value k. SL-Sh CR (i) may include SL-Sh-CR evaluated in suitable slot n-N for transmissions in shared RP with shared priority i. Further, (SL-Sh CR)_{Limit}(k) may correspond to high layer parameter associated with priority value k and SL-Sh-CBR range which includes CBR measured in slot n−N, where N can represent congestion control processing time.

The third module 206 can be configured to communicate one or more output signals. The output signal(s) can, for example, correspond to one or more control signals for allocating resources to indicate a position of the user device.

In one embodiment, the apparatus 102 can correspond to a User Equipment (UE) which can communicate with a device 104 corresponding to a base station. The base station can, for example, correspond to a Next generation Node B (gNB) which can be configured to communicate one or more signals (e.g., input signal(s)) to the UE.

Yet further in view of the foregoing, it is appreciable that the present disclosure generally contemplates a system 100 which can include one or more apparatuses 102 and one or more devices 104. The apparatus(es) 102 and the device(s) 104 can, for example, be capable of being coupled via wired coupling and/or wireless coupling.

It should be appreciated that the embodiments described above can be combined in any manner as appropriate (e.g., one or more embodiments as discussed in the “Detailed Description” section can be combined with one or more embodiments as described in the “Summary of the Invention” section).

It should be further appreciated by the person skilled in the art that variations and combinations of embodiments described above, not being alternatives or substitutes, may be combined to form yet further embodiments.

In one example, the possibility of the output signal(s) being communicated from the apparatus(es) 102 was discussed. It is appreciable that the output signal(s) need not necessarily be communicated from the apparatus(es) 102. Specifically, the possibility that the output signal(s) need not necessarily be communicated outside of the apparatus(es) 102 is contemplated, in accordance with an embodiment of the invention. More specifically, the output signal(s) can, for example, correspond to internal command(s)/instruction(s) (e.g., communicated only within an apparatus 102) for adaptively controlling operational configuration of an apparatus 102, in accordance with an embodiment of the invention.

In the foregoing manner, various embodiments of the disclosure are described for addressing at least one of the foregoing disadvantages. Such embodiments are intended to be encompassed by the following claims and are not to be limited to specific forms or arrangements of parts so described and it will be apparent to one skilled in the art in view of this disclosure that numerous changes and/or modification can be made, which are also intended to be encompassed by the following claims.

### Abbreviations

ACK: acknowledgement
AGC: automatic gain control
BSR: buffer status report
BWP: bandwidth part
CG: configured grant
CS-RNTI: configured scheduling radio network temporary identifier
DCI: downlink control information
GP: guard period
HARQ: hybrid automatic repeat request
MCS: modulation coding scheme
NACK: negative acknowledgement
NDI: new data indicator
NR: new radio
OFDM: orthogonal frequency-division multiplexing
PRB: physical resource block
PRS: positioning reference signal
PSBCH: physical SL broadcast channel
PSCCH: physical SL control channel
PSFCH: physical SL feedback channel
PSSCH: physical SL shared channel
RAN: radio access network
RB: resource block
RP: resource pool
RRC: radio resource control
SCI: sidelink control information
SL: sidelink
SPCI: SL positioning Control Information
S-PSS: SL primary synchronization signal
SR: scheduling request
S-SS: SL synchronization signals
S-SSB: SL synchronization signal block
S-SSS: SL secondary synchronization signal
SL RSSI: sidelink received signal strength indicator
SL CR: sidelink channel occupancy ratio
SL CBR: sidelink channel busy ratio
SL-RNTI: sidelink radio network temporary identifier
SL-P CR: sidelink positioning channel occupancy ratio
SL-P CBR: sidelink positioning channel busy ratio
SL-P RSSI: sidelink positioning received signal strength indicator
SL-Sh CR: sidelink shared channel occupancy ratio
SL-Sh CBR: sidelink shared channel busy ratio
TB: transmission block
UE: user equipment
UL: uplink
WID: work item description

1. A method for controlling congestion in sidelink positioning, the method comprising:
determining a resource pool allocation for selecting resources;
generating at least one parameter based on the resource pool allocation and a past resource selection configuration;
configuring a current resource selection for a user device based on the at least one parameter;
communicating the current resource selection configuration to the user device for controlling congestion in the allocated resource pool.

2. The method according to claim 1, wherein the resource pool allocation comprises a shared resource pool allocation or a dedicated resource pool allocation.

3. The method according to claim 1, wherein the at least one parameter comprises:
sidelink positioning channel occupancy ratio associated with a ratio of occupied subchannels to configured subchannels in sidelink positioning transmissions;
sidelink positioning received signal strength indicator associated with a linear average of received power in sidelink positioning transmissions; and
sidelink positioning channel busy ratio associated with a ratio of a number of subchannels having SL-P RSSI exceeding a predetermined SL-P RSSI threshold to a total number of configured subchannels.

4. The method according to claim 1, further comprising generating at least one combined parameter, wherein the at least one combined parameter comprises:
sidelink shared channel occupancy ratio associated with sidelink positioning channel occupancy ratio and a predetermined weighted score; and
sidelink shared channel busy ratio associated with sidelink positioning channel busy ratio and the predetermined weighted score.

5. The method according to claim 4, further comprising:
generating a shared priority value associated with sidelink priority in a shared resource pool; and
generating the predetermined weighted score.

6. The method according to claim 5, wherein the predetermined weighted score is generated based on at least one of: bandwidth part), a shared resource pool and/or geographical zone(s).

7. The method according to claim 1, further comprising:
determining a periodicity of sidelink positioning reference signal; and
determining a number of subchannels for sidelink positioning.

8. The method according to claim 1, further comprising:
determining a maximum number of sidelink positioning reference signal and/or measurement (re)transmissions; and
determining a maximum SL PRS transmission power.

9. The method according to claim 4, further comprising:
analyzing the at least one parameter and the at least one combined parameter with a preconfigured threshold limit.

10. The method according to claim 7, further comprising adjusting the periodicity of SL PRS, the number of subchannels for sidelink positioning, the maximum number of SL PRS and/or the maximum SL PRS transmission power if the parameter and the combined parameter exceeds the preconfigured threshold limit.

11. A non-transitory computer program comprising instructions which, when the program is executed by a computer, cause the computer to carry out the method according to claim 1.

12. A non-transitory computer readable storage medium having data stored therein representing software executable by a computer, the software including instructions, when executed by the computer, to carry out the method according to claim 1.

13. A device for controlling congestion in sidelink positioning comprising:
a first module configured to obtain data associated with sidelink positioning of a user device;
a second module configured to at least one of process and facilitate the method of claim 1 in a first communication mode to generate at least one output signal; and
a third module configured to communicate at least one output signal,
wherein the output signal corresponds to a control signal for controlling congestion in sidelink positioning.

14. The device according to claim 13, wherein the first communication mode comprises controlling channel load in a dedicated resource pool and/or a shared resource pool.

15. An apparatus for controlling congestion in sidelink positioning comprising:
a first module configured to obtain data associated with sidelink positioning of a user device;
a second module configured to at least one of process and facilitate the method of claim 1 in a second communication mode to generate at least one output signal; and
a third module configured to communicate at least one output signal,
wherein the output signal corresponds to a control signal for controlling congestion in sidelink positioning.

16. The apparatus according to claim 15, wherein the second communication mode comprises modifying transmission parameters to reduce channel load in a dedicated resource pool and/or a shared resource pool.

17. The device and apparatus according to claim 13,
wherein the device corresponds to a base station communicable with the apparatus corresponding to a User Equipment, and
wherein the base station corresponds to a Next generation Node B configured to communicate the at least one output signal to the UE.

18. A system comprising:
at least one device comprising:
a first module configured to obtain data associated with sidelink positioning of a user device;
a second module configured to generate at least one output signal in a first communication mode; and
a third module configured to communicate at least one output signal,
wherein the output signal corresponds to a control signal for controlling congestion in sidelink positioning; and
at least one apparatus comprising:
a first module configured to obtain data associated with sidelink positioning of a user device;
a second module configured to generate at least one output signal in a second communication mode; and
a third module configured to communicate at least one output signal,
wherein the respective second module of each of the at least one device and the at least one apparatus are configured to at least one of process and facilitate the method of claim 1 to generate their respective at least one output signal, and
wherein the apparatus and the device are capable of being coupled via at least one of wired coupling and wireless coupling.
